(19) United States
(12) Patent Application Publication
(10) Pub. No.: US 2016/0167619 A1
(43) Pub. Date: Jun. 16, 2016

(54) Method and System for Preventing Vehicle Theft

(71) Applicant: Avraham Zehavi, Bnei Brak (IL)

(72) Inventor: Avraham Zehavi, Bnei Brak (IL)

(21) Appl. No.: 13/909,120

(22) Filed: Jun. 4, 2013

(51) Int. Cl. B60R 25/042

(52) U.S. Cl. CPC B60R 25/042; B60R 2025/041

(57) ABSTRACT

It is provided a system for controlling operation of an internal combustion engine, connected to a fuel channel which provides pressurized fuel to fuel injectors. The system includes a fuel return line for providing excess fuel from the engine to a fuel tank, a two-way valve having ports connected respectively to the fuel channel and to the fuel return line, and a controller for activating the valve. The valve has a normally open state enabling free fuel passage between the two ports, and an active closed state blocking fuel passage thereof. In the normally open state, fuel passage through the two-way valve decreases fuel pressure in the fuel channel bellow a pressure level appropriate for engine operation by fuel injection. Once the controller activates the valve, the pressure level in the fuel channel enables engine operation by fuel injection. The two-way valve may be controlled wirelessly by an anti-theft lock of a motor vehicle. The first port may be connected to the fuel channel within the engine. The two-way valve may be encapsulated within a protected envelope. The ports of the two-way valve may be made of a metal or a rigid polymer.

### BACKGROUND OF THE INVENTION

1. Field of the invention

The invention is in the field of systems for preventing theft of vehicles, and in special an anti-theft system having a normally open valve for diversion of fuel flow back to a fuel tank unless a controller activates the valve to be closed.

2. Description of related art

Attempts to produce an effective anti-theft device for motor vehicles have been undertaken for many years. Usually, thieves find ways to defeat every new anti-theft device by bypassing the device such as to operate the electrical system or the fuel system and thus re-operate the vehicle. It is an objective if the present invention to provide a valve that prevents vehicle operation unless it is activated by a wireless controller kept by the vehicle owner.

### BRIEF SUMMARY OF THE INVENTION

It is provided according to preferred embodiments of the present invention, a system for controlling operation of an internal combustion engine. The engine is connected to a fuel channel providing pressurized fuel to several fuel injectors. The system includes a fuel return line for providing excess fuel from the engine to a fuel tank, a two-way valve having a first port connected to the fuel channel and a second port connected to the fuel return line, and a controller for activating the two-way valve. The two-way valve has a normally open state enabling free fuel passage between the two ports, and an active closed state blocking fuel passage thereof. In the normally open state, fuel passage through the two-way valve decreases fuel pressure in the fuel channel bellow a pressure level appropriate for engine operation by fuel injection. Once the controller activates the two-way valve, the pressure level in the fuel channel enables engine operation by fuel injection.

In some embodiments, the two-way valve is controlled by an anti-theft lock of a motor vehicle. Preferably, the controller is wirelessly connected to the two-way valve.

In some embodiments, a port of the two-way valve is connected to the fuel channel within the engine.

In some embodiments, the two-way valve is encapsulated within a protected envelope. Preferably, the ports of the two-way valve are made of a metal or a rigid polymer.

It is provided according to preferred embodiments of the present invention, a method for controlling operation of an internal combustion engine. The engine is connected to a fuel channel providing pressurized fuel to several fuel injectors. The method includes a step of providing a system including a fuel return line for providing excess fuel from the engine to a fuel tank, a normally open two-way valve having a first port connected to the fuel channel and a second port connected to the fuel return line. The method also includes a step of activating the two-way valve such that the two-way valve being closed and the pressurized fuel channel enabling engine operation by fuel injection, and a step of de-activating the two-way valve such that the two-way valve returning to a normally open state, decreasing the pressure in the fuel channel, and disabling engine operation by fuel injection.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 is a schematic diagram of a system for controlling an internal combustion engine.

FIG. 2 is a flow chart of a method for controlling an internal combustion engine.

### DETAILED DESCRIPTION OF THE INVENTION

The present invention will now be described in terms of specific example embodiment. It is to be understood that the invention is not limited to the example embodiment disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining certain embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

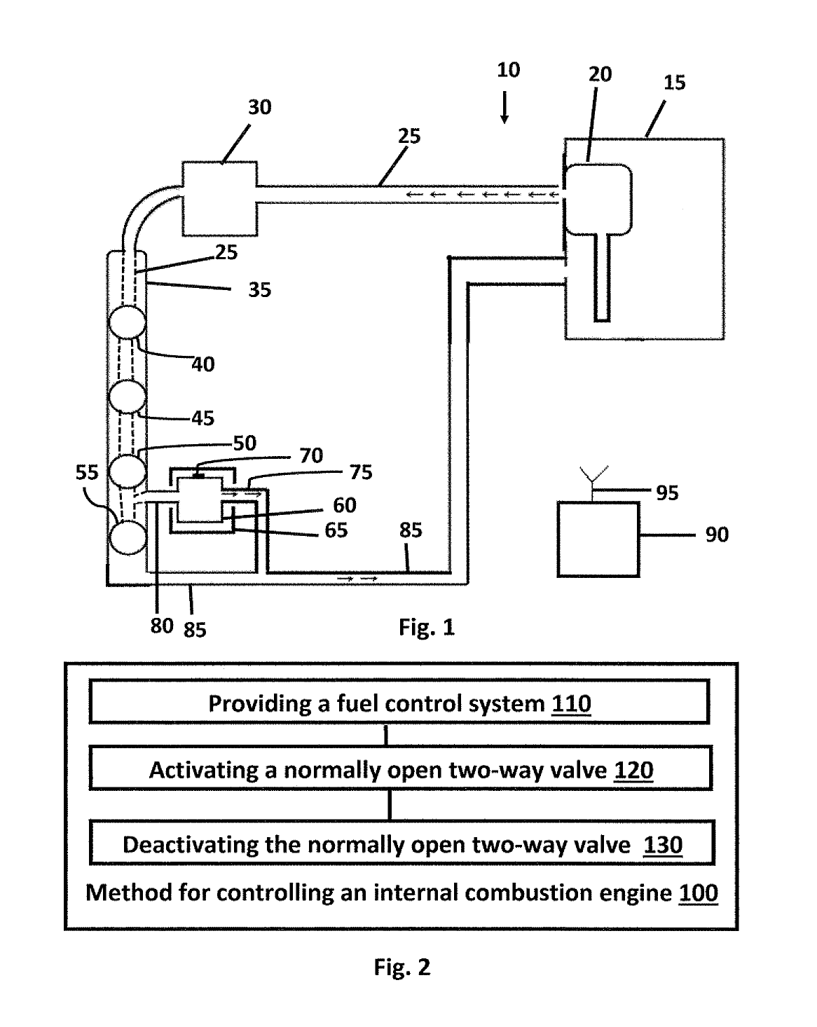

Before describing a system 10 for controlling operation of an internal combustion engine, reference is made to FIG. 1 which outlines fuel management in a modern internal combustion engine 35. A fuel tank 15 stores fuel available for operating engine 35. A fuel pump 20 pumps the fuel from tank 15 into a pressurized fuel channel 25 having an embedded fuel filter 30. Fuel channel 25 extends into engine 35 where it feeds fuel injectors 40, 45, 50 and 55 with pressurized fuel. Excess fuel from engine 35 enters a fuel return line 85 which directs the excess fuel back to fuel tank 15. Gravitation and/or a special pump (not shown) drives the fuel flow back to tank 15.

System 10 for controlling the operation of engine 35 includes a two-way valve 60 having a port 80 connected to fuel channel 25 and a port 75 connected to fuel return line 85, and a controller 90 for activating two-way valve 60. Port 80 is connected to fuel channel 25 within engine 35 between fuel injectors 50 and 55. The connection within engine 35 to the portion of fuel channel 25 used for injection is intended to make it virtually impossible for a thieve to bypass valve 60. Any attempt to change the connection may result in disabling engine 35.

Valve 60 has a normally open state enabling free fuel passage between ports 80 and 75, and an active closed state blocking fuel passage there between.

In the normally open state, fuel passage through valve 60 decreases or reduces fuel pressure in fuel channel 25 bellow a pressure level desired for injecting fuel through injectors 40, 45, 50 and 55. Once controller 90 activates valve 60, fuel is not able to flow through valve 60 and to return line 85. Consequently, the pressure level in fuel channel increases to a desired operating level and fuel is injection into engine cylinders enabling engine operation.

Typically, two-way valve 60 is controlled by an anti-theft lock of a motor vehicle. Thus, if a thieve tries to operate the vehicle, engine 35 fails to operate because of fuel leakage to return line 85, and the thieve fails to drive the vehicle out of a parking lot. Moreover, valve 60 may be disposed in a barely accessible location such as to prevent a thieve from sabotaging valve 60 somehow to close fuel passage thereof.

Furthermore, two-way valve 60 may be encapsulated within a protected envelope or box 65 such that only small portions of ports 75 and 80 are accessible to undesired treatment. In addition or alternatively, ports 75 and 80 of valve 60 may be made of a hard metal or a rigid polymer such that an attempt to close them by applying a brutal squashing power ends up with a total failure or with a leaking break leading to a fuel leakage and inability to build up an operating pressure in fuel channel 25.

Typically, controller 90 has an antenna 95 by which it communicates wirelessly with an antenna 70 of valve 60.

In a preferred embodiment, two-way valve 60 has only two ports and no third way or port.

Referring now to FIG. 2, it is provided a method 100 for controlling operation of an internal combustion engine 60. Engine 60 is connected to a fuel channel 25 providing pressurized fuel to fuel injectors 40, 45, 50 and 55. Method 100 includes a step 110 of providing a system 10 which includes a fuel return line 85 for providing excess fuel from engine 60 to a fuel tank 15, a normally open two-way valve 60 having a port 80 connected to fuel channel 25 and a second port 75 connected to fuel return line 85. Method 100 also includes a step 120 of activating valve 60 such as to close it and enable engine operation by fuel injection from pressurized fuel channel 25. Additionally, method 100 includes a step 130 of de-activating valve 60 such that the two-way valve returning to its normally open state, the pressure in the fuel channel decreases, and engine operation by fuel injection is disabled.

Although the invention has been described in conjunction with specific embodiment thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the example described.

1. A system for controlling operation of an internal combustion engine, the engine being connected to a fuel channel providing pressurized fuel to two or more fuel injectors, the system comprising:
(a) a fuel return line for providing excess fuel from the engine to a fuel tank;
(b) a two-way valve having two ports, a first port connected to the fuel channel and a second port connected to said fuel return line;
(c) said two-way valve having a normally open state enabling free fuel passage between said two ports, and an active closed state blocking fuel passage there between; and
(d) a controller connected to said two-way valve for activating said two-way valve, wherein in said normally open state, fuel passage through said two-way valve decreasing fuel pressure in said fuel channel bellow a pressure level appropriate for engine operation by fuel injection, and once said controller activating said two-way valve, the pressure level in said fuel channel enabling engine operation by fuel injection.

2. The system of claim 1 wherein said two-way valve is controlled by an anti-theft lock of a motor vehicle.

3. The system of claim 1 wherein said first port of said two-way valve is connected to said fuel channel within said engine.

4. The system of claim 1 wherein said two-way valve is encapsulated within a protected envelope.

5. The system of claim 1 wherein at least one port of said two-way valve is made of a hard material selected from the group of hard materials consisting of a metal and a rigid polymer.

6. The system of claim 1 wherein said controller is wirelessly connected to said two-way valve.

7. A method for controlling operation of an internal combustion engine, the engine being connected to a fuel channel providing pressurized fuel to two or more fuel injectors, the method comprising:
(a) providing a system including
(i) a fuel return line for providing excess fuel from the engine to a fuel tank; and
(ii) a normally open two-way valve having two ports, a first port connected to the fuel channel and a second port connected to said fuel return line;
(b)activating said normally open two-way valve such that said two-way valve being closed and the pressurized fuel channel enabling engine operation by fuel injection; and
(c) de-activating said normally open two-way valve such that said two-way valve returning to its normally open state, decreasing the pressure in said fuel channel, and disabling engine operation by fuel injection.

8. The method of claim 7 wherein said activating and said de-activating are communicated wirelessly to said two-way valve.

9. The method of claim 7 wherein the method serves an anti-theft system of a motor vehicle.
